(19) United States
(12) Patent Application Publication
(10) Pub. No.: US 2013/0336493 A1
(43) Pub. Date: Dec. 19, 2013

(54) FLEXIBLE MICROPHONE AND AMPLIFICATION SYSTEM

(71) Applicant: First Act, Inc., (US)

(72) Inventor: Ilissa Brooke Schild, Boston, MA (US)

(73) Assignee: FIRST ACT, INC., Boston, MA (US)

(21) Appl. No.: 13/839,592

(22) Filed: Mar. 15, 2013

Related U.S. Application Data
(60) Provisional application No. 61/660,950, filed on Jun. 18, 2012.

(51) Int. Cl. H04R 1/08

(52) U.S. Cl. CPC H04R 1/08
USPC 381/61; 381/365

(57) ABSTRACT

A flexible microphone and amplification system is disclosed. The system includes a first end supporting a first device and a second end supporting a second device. A flexible portion connects the first end to the second end. The flexible portion is bendable and twistable and can be contorted into various shapes to support the first end and second end in various positions.

### CROSS-REFERENCE TO RELATED APPLICATION

This application claims priority to earlier filed U.S. Provisional Application Ser. No. 61/660,950, filed Jun. 18, 2012, the contents of which are incorporated herein by reference.

### BACKGROUND OF THE INVENTION

1. Field of the Invention

The present patent document relates generally to microphones and amplification systems, and more particularly to a microphone amplification system that includes a flexible portion that may be contorted into various shapes.

2. Background of the Related Art

Handheld microphones and voice amplifiers have become ubiquitous in our day to day lives and are extensively used in the entertainment industry, radio and television broadcasting, and public speaking. Microphones in various shapes, sizes and configurations can be found in music recording studios, computer equipment, telephones, tape recorders, karaoke systems, hearing aids, megaphones, mobile devices, and toys.

### SUMMARY OF THE INVENTION

In one aspect, the present invention features a flexible microphone and amplification system that is bendable and twistable and can be contorted into various shapes to form a hands-free, standalone microphone platform. It also permits users to attach the microphone to themselves by wrapping it around their torso or any extremity. This allows for hands-free operation of the microphone. The microphone can include one or more buttons that users can utilize to add sound effects, enhancing the enjoyment and creativity.

In another aspect, the invention features an apparatus having a first end for supporting a first device, a second end supporting a second device, and a flexible portion connecting the first end to the second end. The flexible portion can be contorted into various shapes to support the first end and second end in various positions.

One or more of the following features may also be included. The first device can be a microphone, cell phone, or other electronic mobile device. The second device can include an amplifier or speaker electrically connected to the first device. A voice effects button can be electrically connected to the first device, second device, or to both the first device and second device. The voice effects can include echo, flanger, phaser, chorus, equalization, filtering, overdrive, pitch shift, time stretching, resonators, robotic voice effects, synthesizer, modulations, compression, or any combination thereof. The flexible portion can include three layers. The flexible portion can include an outer layer. The flexible portion can include an outer foam layer. A fabric sleeve can be disposed over the outer foam layer. The flexible portion can include an inner ductile core. The ductile core can be a metal wire made of aluminum, steel, copper, or other metal. The metal wire can include a vinyl jacket. The flexible portion can include a middle layer made of corrugated plastic tubing.

In another aspect, the invention features an apparatus having a first end supporting a microphone, a second end supporting an amplifier and speaker electrically connected to the microphone, and an elongate, flexible middle portion connecting the first end to the second end. The flexible middle portion is bendable and twistable and can be contorted into various shapes to support the first end and second end in various positions.

One or more of the following features may also be included. A voice effects button can be electrically connected to the amplifier. The flexible portion can include a ductile core, a middle layer and an outer layer. The ductile core can be an aluminum wire, the middle layer can be a corrugated plastic tubing and the outer layer can be a foam such as ethylene vinyl acetate.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the flexible microphone and amplification system;

FIG. 2 is a partial cross-section view of the flexible middle portion of the system; and

FIG. 3 illustrates cross-sectional views of various embodiments of the flexible portion of the system.

### DESCRIPTION OF THE PREFERRED EMBODIMENT

Generally, the present invention provides a flexible support mechanism that can be integrated with mobile electronic devices, microphones, and other such devices. The flexible mechanism can be manipulated and contorted into various shapes to rigidly support the devices in various positions.

Aspects disclosed herein, which are in accordance with various embodiments, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Moreover, the systems described herein may be configured to include or exclude any of the functions discussed herein.

Thus, the embodiments of the present invention are not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

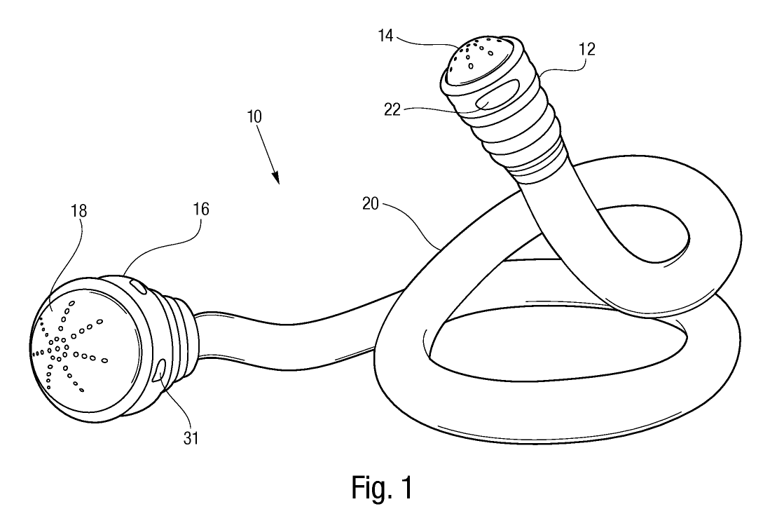

Referring now to FIG. 1, the flexible microphone and amplification system is shown generally at 10. The system includes a first end 12 supporting a first device 14 and a second end 16 supporting a second device 18. An elongate, flexible middle portion 20 connects the first end 12 to the second end 16. The first end 12 and second end 16 can be attached to the flexible portion 20 with glue, clamps, fastening hardware, etc. The middle portion 20 is bendable and twistable and can be contorted into various shapes to support the first end and second end in various positions.

In a preferred embodiment, the first device 14 is a microphone and the second device 18 is an amplifier and speaker. Because the system 10 is bendable and twistable and can be contorted into various shapes, it permits users to attach the system 10 to themselves by wrapping it around their torso or any extremity. The system 10 may also be contorted to stand on its own. This allows for hands-free operation of the system.

The microphone and/or amplifier can include one or more buttons 22 that users can utilize to add sound effects, such as echo, flanger, phaser, chorus, equalization, filtering, overdrive, pitch shift, time stretching, resonators, robotic voice effects, synthesizer, modulations, compression, and others as is known in the art.

In one embodiment, the first end 12 of the system 10 can include the microphone (first device 14) and sound effect buttons 22, while the second end 16 can include an amplifier and speaker (second device 18), internal battery (not shown), and power button 31.

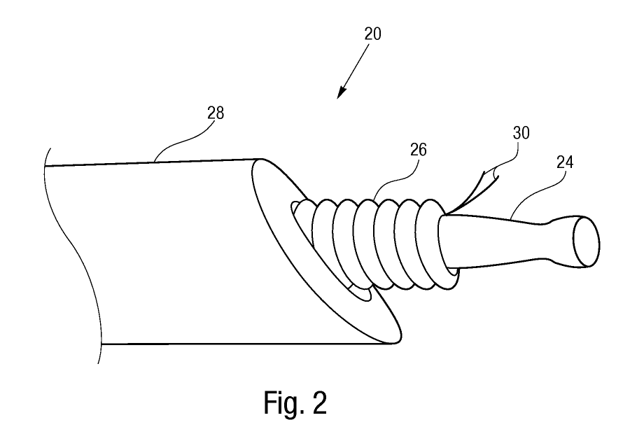

The two ends 12, 16 of the system 10 are connected by an elongated flexible portion 20 that is bendable and twistable. Referring to FIG. 2, the flexible portion 20 may include a number of layers and sublayers. For instance, the flexible portion 20 may include a conductive, ductile core 24, a middle layer 26 and an outer layer 28. The ductile core 24 is at the center and provides the flexibility and moldability of the system 10. The ductile core 24 can be any conductive metal wire, such as an aluminum wire (3 mm in diameter). A steel, copper, or other flexible metal wire can be utilized instead of aluminum. The metal wire, if used, may be coated in an optional vinyl jacket. The ductile core 24 should be of sufficient gauge to securely or rigidly support the first device and second device in various positions, while maintaining its flexibility properties so that it can be contorted into the various shapes.

The middle layer 26 may be corrugated plastic tubing, which overlays the ductile core 24 and functions to hide kinking of metal wires that may be used as the ductile core 24, such as aluminum wire, resulting from continuous use, and also provides a buffer for safety purposes in the event a metal wire breaks. The corrugated tubing 26 also provides additional structural support to permit the flexible portion 20 to retain any shape it has been contorted into.

The outer layer 28 may be made of ethylene vinyl acetate (“EVA”) foam, spray foam or other similar substance, and can overlay the corrugated tubing 26 and ductile core 24 to form the exterior of the flexible portion 20. The EVA foam may contain an anti-wrinkle agent. Closed-cell foam and/or open-cell foam can also be used for the outer layer 28. The foam may be covered in an optional fabric sleeve. The outer layer 28 provides appealing aesthetics and is soft to the touch.

Separate insulated wires 30 can run along the length of the ductile core 24 to connect the microphone to the speaker and battery.

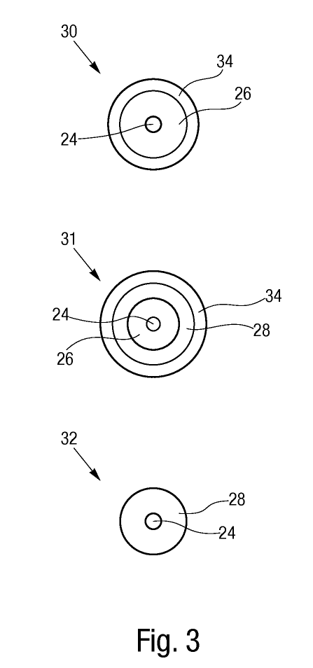

Referring to FIG. 3, cross-sectional views of other embodiments of the flexible portion 20 are illustrated at 30, 31, and 32. In one embodiment 30, the flexible portion 20 can include a conductive core 24, encased by a corrugated tubing 26. A fabric sleeve 34 can overlay the corrugated tubing 26. Outer layer 28 is not utilized in this particular configuration.

In embodiment 31, the flexible portion 20 includes a conductive metal core 24 that is encased by a flexible corrugated plastic tubing 26. An outer layer 28 of spray foam or EVA foam can overlay the corrugated tubing 26, and a fabric sleeve 34 can be disposed over the outer layer 28.

In embodiment 32, the flexible portion 20 simply includes a conductive core 24 that is encased in an outer layer 28 of EVA foam.

In other embodiments, the present invention can be integrated with mobile electronic devices to provide users with hands free operation of their cell phones and other mobile devices. For example, instead of connecting a microphone to an amplifier and/or speaker, one end of the flexible portion 20 can be coupled to a cell phone holder and users can manipulate the flexible portion 20 into various shapes to form a hands-free stand for a cell phone. Alternatively, users can wrap the flexible portion around their torso or an extremity to permit hands-free operation of a cell phone while walking or running. In such embodiments, the amplifier/speaker portion need not be included. As another example, the microphone housing attached to one end of the flexible portion 20 can be coupled to a cell phone holder, so that the microphone 14 can pick up audio from the cell phone's speaker and can then amplify the audio via the amplifier/speaker. In such a configuration, users can manipulate the flexible portion to form a hands-free stand, or wrap the flexible portion around an extremity to permit hands-free operation while walking, running, etc.

Therefore, it can be seen that the present invention provides a unique solution to the problem of providing a system that can provide a hands-free method of supporting a device, such as a microphone and speaker or electronic mobile device, and, in the case of children, provide an entertaining enhancement to a toy that might be perceived as boring otherwise.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An apparatus, comprising:
a first end supporting a first device;
a second end supporting a second device; and
a flexible portion connecting the first end to the second end;
whereby the flexible portion can be contorted into various shapes to support the first end and second end in various positions.

2. The apparatus of claim 1, wherein the first device is any one of a microphone, cell phone, or other electronic mobile device.

3. The apparatus of claim 1, wherein the second device is an amplifier or speaker electrically connected to the first device.

4. The apparatus of claim 1, further comprising a voice effects button electrically connected to any one of the first device, second device, or combination thereof.

5. The apparatus of claim 4, wherein the voice effects are selected from the group consisting essentially of echo, flanger, phaser, chorus, equalization, filtering, overdrive, pitch shift, time stretching, resonators, robotic voice effects, synthesizer, modulations, compression, or any combination thereof.

6. The apparatus of claim 1, wherein the flexible portion comprises three layers.

7. The apparatus of claim 1, wherein the flexible portion has an outer layer

8. The apparatus of claim 1, wherein the flexible portion has an outer foam layer.

9. The apparatus of claim 8, further comprising a fabric sleeve over the outer foam layer.

10. The apparatus of claim 1, wherein the flexible portion has an inner ductile core.

11. The apparatus of claim 10, wherein the ductile core is a metal wire.

12. The apparatus of claim 11, wherein the ductile core is an aluminum wire.

13. The apparatus of claim 11, wherein the ductile core is a steel wire.

14. The apparatus of claim 10, wherein the metal wire has a vinyl jacket.

15. The apparatus of claim 1, wherein the flexible portion includes a middle layer.

16. The apparatus of claim 15, wherein the middle layer is corrugated plastic tubing.

17. An apparatus, comprising:
a first end supporting a microphone;
a second end supporting an amplifier electrically connected to the microphone; and
an elongate, flexible middle portion connecting the first end to the second end;
whereby the middle portion is bendable and twistable and can be contorted into various shapes to support the first end and second end in various positions.

18. The apparatus of claim 17, further comprising a voice effects button electrically connected to the amplifier.

19. The apparatus of claim 17, wherein the middle portion comprises a ductile core, a middle layer and an outer layer.

20. The apparatus of claim 19, wherein the ductile core is an aluminum wire, the middle layer is a corrugated plastic tubing and the outer layer is foam.
